(19) United States
(12) Patent Application Publication
(10) Pub. No.: US 2008/0212753 A1
(43) Pub. Date: Sep. 4, 2008

(54) TERMINAL APPARATUS, CALL SWITCHING METHOD, AND RECORDING MEDIUM HAVING STORED THEREIN CALL SWITCHING PROGRAM

(75) Inventor: Hiroyuki YOSHIZAWA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/020,022

(22) Filed: Jan. 25, 2008

(30) Foreign Application Priority Data
Jan. 26, 2007 (JP) 2007-16309

(51) Int. Cl. H04B 1/00

(52) U.S. Cl. 379/110.01

(57) ABSTRACT

A terminal apparatus capable of performing a normal call and a hand-free call comprising an imaging unit that images an image; a detecting unit that detects a position of the terminal apparatus using the image imaged by the imaging unit; and a call switching unit that switches the normal call and the hand-free call on the basis of a result of the detection of the detecting unit.

### CROSS-REFERENCE TO RELATED APPLICATIONS

This application is based upon and claims the benefit of priority from the prior Japanese Patent Application No. 2007-016309, filed on Jan. 26, 2007, the entire content of which is incorporated herein by reference.

### BACKGROUND

1. Field

The present disclosure relates to a terminal apparatus having a call function, which is exemplified by a cellular phone, capable of performing a normal call, a hand-free call, a television telephone call, and the like. More particularly, the present disclosure relates to a terminal apparatus in which call switching among the normal call, the hand-free call, and the television telephone call are automated; a call switching method for the terminal apparatus; and a recording medium having stored therein a call switching program.

2. Description of Related Art

The normal call includes a call performed by a user of the terminal apparatus holding the terminal apparatus close to the ear of the user. The hand-free call includes a form of call performed by the user of the terminal apparatus holding the terminal apparatus away from the user and includes, in a broader sense, the television telephone call.

The “call” may include forms other than both-way communication by sound and can include, for example, a form in which only received sound is output from a terminal apparatus, while the user of the terminal apparatus himself/herself does not speak.

In a portable terminal apparatus such as a cellular phone that is capable of performing the normal call and the hand-free call, call switching is performed by, for example, causing a receiver or a speaker to output sound or changing the volume of the normal call and the hand-free call with the receiver and the speaker.

Concerning such a portable terminal apparatus, Japanese Patent Laid-Open No. 2001-223784 (abstract and FIG. 1) discloses a configuration in which a sensor that detects contact/non-contact states of the portable terminal and the ear of a caller and outputs an ON signal and an OFF signal representing the contact/non-contact states of the ear. By switching a switching circuit with the ON signal and the OFF signal, a sound signal from a call partner is outputted to a receiver amplifier when the portable terminal is in contact with the ear of the caller and the sound signal is outputted to a speaker amplifier when the portable terminal is in non-contact with the ear of the caller.

Japanese Patent Laid-Open No. 10-28169 (paragraphs 0011 and 0012 and FIG. 2) discloses that an infrared ray is irradiated on a human body from an infrared-emitting element during a call and reflected light of the infrared ray is received by an infrared-receiving element, whereby it is detected that the human body such as the face or the ear approaches or comes into contact with a cellular phone and a normal call and a hand-free call are switched according to a signal of the detection.

Convenience of the portable terminal apparatus is improved by switching a form of call according to a positional relation between an apparatus main body and a human body. However, since a mechanical sensor detects contact between the portable terminal and the ear using a contact point via a spring and changes over a switching circuit according to a signal of the detection, a mechanical detection operation causes a temporal delay in the switching of call.

When the contact or the approach of the human body is detected by reflected light of the infrared ray, it is necessary to set the infrared-emitting element and the infrared-receiving element in the portable terminal apparatus and set a light-emitting circuit and a light-receiving circuit for the elements. Such components lead to excessive consumption of a battery.

### SUMMARY

An object of the present disclosure is to facilitate and automate switching between the normal call and the hand-free call for a portable terminal apparatus that is capable of performing a normal call and a hand-free call including a television telephone call.

In one aspect, a terminal apparatus capable of performing a normal call and a hand-free call comprising: an imaging unit that images an image; a detecting unit that detects a position of the terminal apparatus using the image imaged by the imaging unit; and a call switching unit that switches the normal call and the hand-free call on the basis of a result of the detection of the detecting unit.

Further, in one aspect of the terminal apparatus, the hand-free call is a call performed by using a television telephone function, and the call switching unit automatically switches the normal call and the television telephone call on the basis of a result of the detection of the detecting unit.

Moreover, the terminal apparatus, The terminal apparatus may further comprising: a receiver that outputs sound; and a speaker that outputs sound, wherein the call switching unit causes the receiver to output sound in the normal call and causes the speaker to output sound in the hand-free call.

Further, in one aspect of the terminal apparatus, the call switching unit, according to a result of the detection of the detecting unit switches, a call to the normal call when the terminal apparatus is in a position of an ear of a user of the terminal apparatus and switches a call to the hand-free call when the terminal apparatus is apart from the position of the ear of the user of the terminal apparatus.

Further, in one aspect of the terminal apparatus, a threshold for the image is set in the detecting unit, and the call switching unit switches the normal call and the hand-free call on the basis of a result of comparison of the image and the threshold.

Further, in another aspect of the terminal apparatus, the detecting unit starts the imaging unit at predetermined time intervals and captures images during a call by the terminal apparatus.

Moreover, in another aspect of the terminal apparatus, the detecting unit captures images imaged by the imaging unit at predetermined time intervals during a call by the terminal apparatus.

In further another aspect of the terminal apparatus, the detecting unit detects a position of the terminal apparatus according to color components in the image imaged by the imaging unit.

Further, in another aspect of the terminal apparatus, the detecting unit detects a position of the terminal apparatus according to a quantity of black elements in the image imaged by the imaging unit.

Moreover, in another aspect of the terminal apparatus, an external apparatus that inputs and outputs sound is connected to the terminal apparatus by wire or radio, and the call switching unit switches a call to a call performed by using the external apparatus when the external apparatus is connected to the terminal apparatus.

In another aspect, a call switching method of switching a first call operation and a second call operation comprising: detecting a position of a communication apparatus according to an imaged image; and switching the first call operation and the second call operation on the basis of a result of the detection of the communication apparatus position.

Further, in another aspect of the call switching method, the first call operation is a normal call and the second call operation is a hand-free call, and according to the imaged image, a call is switched to the normal call when the communication apparatus is in a position of an ear of a user and switched to the hand-free call when the communication apparatus is apart from the position of the ear.

Further, in another aspect of the call switching method, the imaged image is captured at predetermined time intervals during a call performed by using the communication apparatus, and the first call operation and the second call operation are switched on the basis of the captured image.

Moreover, the call switching method may further comprising switching the first call operation and the second call operation according to color components in the captured image.

In another aspect, a recording medium mounted on a communicatable terminal apparatus and having readably stored therein a call switching program for causing a computer to execute: capturing an image representing a position of the terminal apparatus; and switching a normal call and a hand-free call on the basis of the captured image.

Further, the call switching program stored in the recording medium may, according to the captured image, a call is switched to the normal call when the terminal apparatus is in a position of an ear of a user and switched to the hand-free call when the terminal apparatus is apart from the position of the ear.

Furthermore, in another aspect of the call switching program stored in the recording medium, the captured image is captured at predetermined intervals during a call, and the normal call and the hand-free call are switched on the basis of the captured image.

Further, in another aspect of the call switching program stored in recording medium, the normal call and the hand-free call are switched according to color components in the captured image.

### BRIEF DESCRIPTION OF THE DRAWINGS

FIGS. 1A and 1B are diagrams showing an automatic call switching function of a portable terminal apparatus according to a first embodiment.

FIG. 2 is a diagram showing call performed by gripping the portable terminal apparatus.

FIG. 3 is a flowchart showing an example of a call switching method for the portable terminal apparatus.

FIG. 4 is a diagram showing an example of a configuration of hardware of the portable terminal apparatus.

FIG. 5 is a diagram showing an example of the structure of the portable terminal apparatus.

FIG. 6 is a diagram showing a hierarchical structure of software processing by the portable terminal apparatus.

FIG. 7 is a flowchart showing a processing procedure during start of call of a call switching program.

FIG. 8 is a flowchart showing a processing procedure during call of the call switching program.

FIG. 9 is a diagram showing call switching based on a detected image.

FIG. 10 is a flowchart showing a processing procedure of a call switching program of a portable terminal apparatus according to a second embodiment.

FIG. 11 is a diagram showing an automatic call switching function of a portable terminal apparatus according to a third embodiment.

FIG. 12 is a flowchart showing an example of a call switching method for the portable terminal apparatus.

FIG. 13 is a diagram showing an example of a configuration of hardware of the portable terminal apparatus.

FIG. 14 is a diagram showing an example of the structure of the portable terminal apparatus.

FIG. 15 is a diagram showing an example of a configuration of hardware of a headset.

FIG. 16 is a diagram showing an example of the structure of the headset.

FIG. 17 is a diagram showing a hierarchical structure of software processing by the portable terminal apparatus.

FIG. 18 is a flowchart showing a processing procedure of a call switching program for the portable terminal apparatus.

FIG. 19 is a diagram showing an automatic call switching function of a portable terminal apparatus according to a fourth embodiment.

FIG. 20 is a diagram showing an example of a configuration of hardware of the portable terminal apparatus.

FIG. 21 is a diagram showing call switching based on a detected image according to another embodiment.

### DETAILED DESCRIPTION OF THE PREFERRED EMBODIMENTS

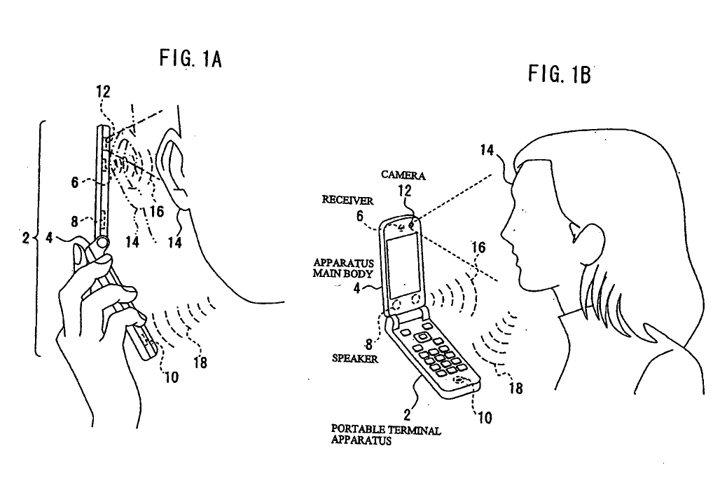

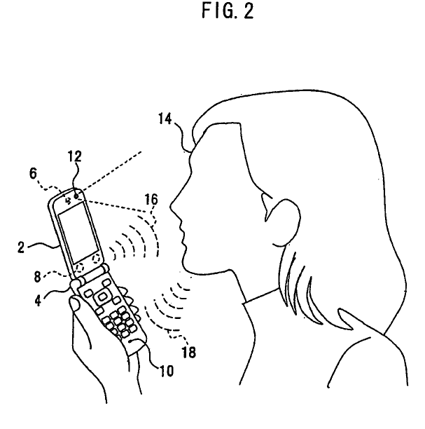

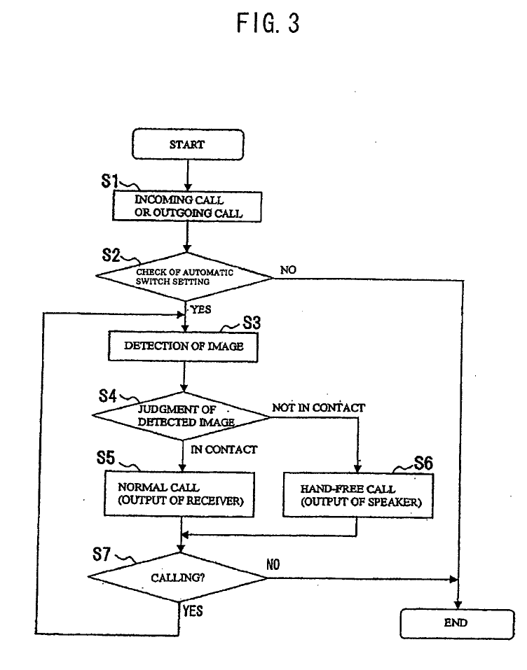

A first embodiment is explained with reference to FIGS. 1A and 1B, FIG. 2, and FIG. 3. FIGS. 1A and 1B are diagrams showing an automatic call switching function of a portable terminal apparatus. FIG. 1A is a diagram showing a normal call and FIG. 1B is a diagram showing a hand-free call. FIG. 2 is a diagram showing a form of call performed by gripping the portable terminal apparatus, i.e., the hand-free call. FIG. 3 is a flowchart showing an example of a call switching method for the portable terminal apparatus.

A portable terminal apparatus 2 according to this embodiment includes, as shown in FIG. 1, a receiver 6, a speaker 8, a microphone 10, and a camera 12 in an apparatus main body 4 and is capable of performing the normal call and the hand-free call or a television telephone call. The receiver 6 is a receiver that is placed in contact with the ear and outputs sound. The speaker 8 is a speaker that outputs sound in a state away from the ear. The normal call of the portable terminal apparatus 2 is a call performed by causing the receiver 6 to output sound. The hand-free call is a call performed by causing the speaker 8 to output sound. In the hand-free call, as shown in FIG. 2, the apparatus main body 4 may be held by the hand.

The camera 12 is an in-camera such as a television telephone camera that can photograph a user who is using the portable terminal apparatus 2. The camera 12 constitutes a detecting unit that detects a position of the apparatus main body 4 using an image, in particular, a position between the apparatus main body 4 and the user of the portable terminal apparatus 2. The position of the apparatus main body 4 detected by the camera 12 is, as shown in FIG. 1A, a position of the apparatus main body 4 in a state in which the apparatus main body 4 indicated by an alternate long and two short dashes line is in contact with a human body 14 or a state in which the human body 14 indicated by a solid line is near the apparatus main body 4.

As shown in FIG. 3, the portable terminal apparatus 2 checks, on the basis of the start of an incoming call or an outgoing call by, for example, the depression of a call button (step S1), presence or absence of an automatic switch setting for call switching (step S2). When there is no automatic switch setting, the portable terminal apparatus 2 finishes the processing in FIG. 3. On the other hand, when there is the automatic switch setting, the portable terminal apparatus 2 starts the camera 12 to perform image detection (step S3) and captures a detected image. The portable terminal apparatus 2 judges, on the basis of the detected image, whether the apparatus main body 4 is in contact with the human body 14 or is near the human body 14 (step S4). The detected image tends to be dark when the human body 14 approaches the camera 12 and tends to be light when the human body 14 moves away from the camera 12. Therefore, paying attention to color components of the detected image, for example, a threshold is set for black elements in pixels and it is judged whether black elements in the detected image exceed the threshold. Consequently, it is possible to learn whether the apparatus main body 4 is in contact with or near the human body 14.

If the apparatus main body 4 is in contact with the human body 14 shown in FIG. 1A or near the human body 14, the portable terminal apparatus 2 causes the receiver 6 to output reception sound 16 from a communication partner and switches the hand-free call to the normal call (step S5). In this case, transmission sound 18 is captured from the microphone 10.

When it is judged that the apparatus main body 4 is not in contact with the human body 14 or is not near the human body 14 (FIG. 1B or FIG. 2), the portable terminal apparatus 2 causes the speaker 8 to output the reception sound 16 from the communication partner and switches the normal call to the hand-free call (step S6). In this case, as in the above case, the transmission sound 18 is captured from the microphone 10.

After the call switching, the portable terminal apparatus 2 judges whether the user is currently making a call (step S7). When the user is not currently making a call (NO in step S7), the portable terminal apparatus 2 finishes the processing in FIG. 3. When the user is currently making a call (YES in step S7), the portable terminal apparatus 2 returns to step S3 and continuously monitors a change of detected images. As long as the call is continued, the portable terminal apparatus 2 automatically and continuously performs call switching on the basis of the detected images (steps S3 to S7).

In this way, if a position of the apparatus main body 4 with respect to the human body 14 is monitored with a detected image of the camera 12 to check, for example, whether the apparatus main body 4 is in contact with the human body 14, it is possible to automatically switch the normal call and the hand-free call according to the detected image. Therefore, the call switching is facilitated and convenience of the portable terminal apparatus 2 is improved.

In this case, concerning the normal call and the television telephone call, as shown in FIG. 2, the normal call shown in FIG. 1A can be automatically switched to the television telephone call shown in FIG. 1B or FIG. 2 or the television telephone call can be automatically switched to the normal call according to whether the apparatus main body 4 is in contact with or near the human body 14. Special switching operation by the user is unnecessary. Even after starting the television telephone call, when the user does not wish to transmit an image to a partner, the user can switch to the normal call and continue the call without transmitting the image if the user places the apparatus main body 4 in contact with the ear as shown in FIG. 1A without stopping the call.

To capture a detected image, a new camera may be set as a sensor unit for the call switching. However, if the existing camera 12 is present in the portable terminal apparatus 2 as described above, the camera 12 can be utilized as the detecting unit. Therefore, in the portable terminal apparatus 2 according to this embodiment, a special device is not required, the call switching is automated and facilitated, and an increase in cost and an increase in the number of components are not caused.

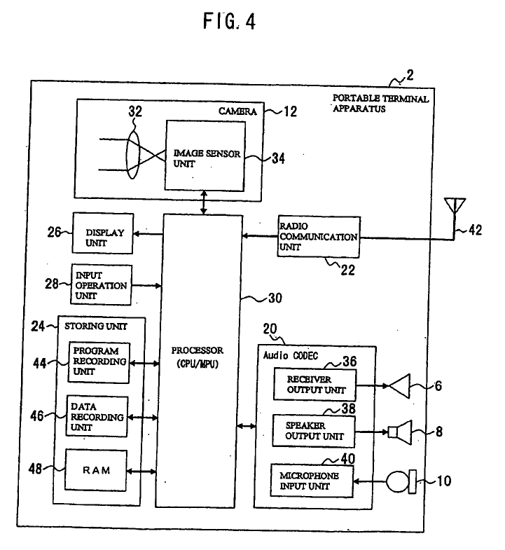

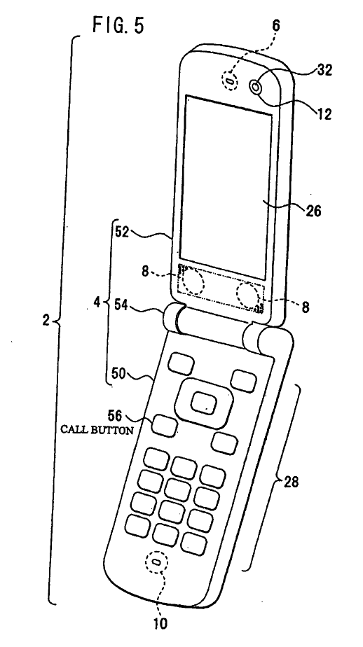

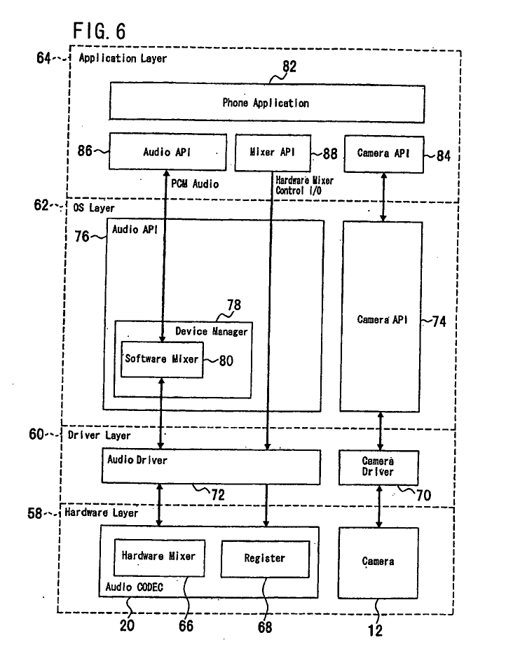

The portable terminal apparatus 2 is next explained with reference to FIGS. 4, 5, and 6. FIG. 4 is a diagram showing an example of a configuration of hardware of the portable terminal apparatus 2. FIG. 5 is a diagram showing an example of the structure of the portable terminal apparatus 2. FIG. 6 is a diagram showing a hierarchical structure of software processing by the portable terminal apparatus 2. In FIGS. 4, 5, and 6, components identical with those in FIGS. 1A and 1B are denoted by the identical reference numerals.

The portable terminal apparatus 2 includes the camera 12, an audio codec 20, a radio communication unit 22, a storing unit 24, a display unit 26, an input operation unit 28, and a processor 30 and is capable of performing automatic switching of the normal call and the hand-free call.

As described above, the camera 12 is the television telephone camera and constitutes the image detecting unit that detects a position of the apparatus main body 4. The camera 12 includes an optical system 32 and an image sensor unit 34. The optical system 32 is means for capturing light from the human body 14 as a subject and causing the light to enter the image sensor unit 34 or focus on the image sensor unit 34. The image sensor unit 34 converts a detected image into an electric signal according to the entrance of the light or the focusing of the light from the optical system 32. The detected image is positional information representing a position of the apparatus main body 4. The image sensor unit 34 can include a CCD (Charge Coupled Device), CMOS (Complementary Metal Oxide Semiconductor) element or the like that converts an image into an electric signal. An image detected by the image sensor unit 34 is captured into the storing unit 24 and stored therein at all times or predetermined time intervals according to the control by the processor 30.

The audio codec 20 is an input and output unit and a signal processing unit for a sound signal and is a call switching unit that switches a sound path. The audio codec 20 performs, according to the control by the processor 30, conversion of a digital audio signal into an analog audio signal, conversion of an analog audio signal into a digital audio signal, capturing of transmission sound, switching of a sound path of reception sound, and the like. The audio codec 20 includes a receiver output unit 36, a speaker output unit 38, and a microphone input unit 40. In the case of the normal call, a sound signal is outputted from the receiver output unit 36 to the receiver 6. In the case of the hand-free call, a sound signal is outputted from the speaker output unit 38 to the speaker 8. In all the call forms, transmission sound detected by the microphone 10 is captured into the microphone input unit 40.

The radio communication unit 22 includes an antenna 42 and performs radio communication with a base station through the antenna 42. The radio communication by the radio communication unit 22 is performed according to the control by the processor 30. The radio communication unit 22 performs transmission and reception of a radio signal. The radio communication unit 22 includes a signal processing unit such as a baseband unit. The radio communication unit 22 superimposes a sound signal and a packet data signal on a carrier wave to generate a transmission signal or generates a sound signal and a packet data signal from a received radio signal.

The display unit 26 is a user interface and displays input information and output information as a video on the basis of the control by the processor 30. In this case, an LCD (Liquid Crystal Display) is set as a video display and output unit.

The input operation unit 28 is a user interface and performs character input and the like by user operation on the basis of the control by the processor 30. The input operation unit 28 includes a keyboard including plural character keys and a cursor key and captures input information such as characters and signs by input operation into the processor 30 according to the control by the processor 30. The input operation unit 28 includes a call button that starts a call.

The storing unit 24 is a recording medium capable of reading out and writing information according to the control by the processor 30. The storing unit 24 includes a program recording unit 44, a data recording unit 46, and a RAM (Random Access Memory) 48. The program recording unit 44 is, for example, a ROM (Read Only Memory). An OS (Operating System), a telephone application program, a call switching program as application software, and the like are stored in the program recording unit 44. The call switching program is software for realizing the call switching method mentioned above according to information processing. Specifically, the call switching program is a sound-path-switching judging program that operates on the basis of a detected image of the camera 12 with the telephone application program as a background. The detected image captured by the camera 12 is stored in the data recording unit 46.

The OS and the call control program are expanded in the RAM 48 according to the control by the processor 30. The RAM 48 functions as a work area. In other words, the processor 30 and the RAM 48 execute various kinds of control such as capturing of various kinds of information according to the execution of the call control program.

The processor 30 is a central part of a computer that performs information processing in accordance with a program and is a control unit for various functional units including a CPU (Central Processing Unit) and an MPU (Micro Processor Unit). The processor 30 expands the OS and the call switching program recorded in the program recording unit 44 in the RAM 48 and executes the OS and the call switching program. The processor 30 captures a detected image from the camera 12, monitors a change in the captured detected image, and switches a sound path of the audio codec 20 on the basis of the detected image, i.e., controls the call switching. Therefore, the processor 30 forms a part of an operation of a call-switching control unit.

In the portable terminal apparatus 2, as shown in FIG. 5, a first housing unit 50 and a second housing unit 52 are foldably coupled by a hinge section 54 to constitute the apparatus main body 4. Besides such a folding structure, the apparatus main body 4 may have a draw-out structure and a laterally opening and closing or rotating structure. In the housing 50, the microphone 10 is set and the input operation unit 28 including the plural keys is also set. In the input operation unit 28, a call button 56 for starting a call is set. In the housing unit 52, the display unit 26 is set, the receiver 6 and the camera 12 are set above the display unit 26, and the speaker 8 is set below the display unit 26.

Concerning the software processing for the automatic call switching in the portable terminal apparatus 2, as shown in FIG. 6, four layers including a hardware layer 58, a driver layer 60, an OS layer 62, and an application layer 64 are set. In the hardware layer 58 as a physical layer, the camera 12 and the audio codec 20 are set. In the audio codec 20, a hardware mixer 66 and a register 68 are set.

In the driver layer 60, a camera driver 70 corresponding to the camera 12 and an audio driver 72 corresponding to the audio coded 20 are set. In the OS layer 62, a camera application 74 corresponding to the camera driver 70 and an audio application 76 corresponding to the audio driver 72 are set. Specifically, a software mixer 80 of a device manager 78 of the audio application 76 corresponds to the audio driver 72.

In the application layer 64, a camera application 84, an audio application 86, and a mixer application 88 are set with a telephone application 82 as a background. The audio application 86 cooperates with the software mixer 80 according to PCM (Pulse Code Modulation) audio. The mixer application 88 is a hardware mixer control I/O and cooperates with the audio driver 72.

In such structure, the camera 12 detects an image showing whether the apparatus main body 4 is in contact with or near the human body 14. The detected image is captured into the camera application 74 through the camera driver 70. The sound path is controlled by the hardware mixer 66 and the software mixer 80. As a result, automatic switching of the normal call and the hand-free call and automatic switching of the normal call and the television telephone call are executed according to the image detection.

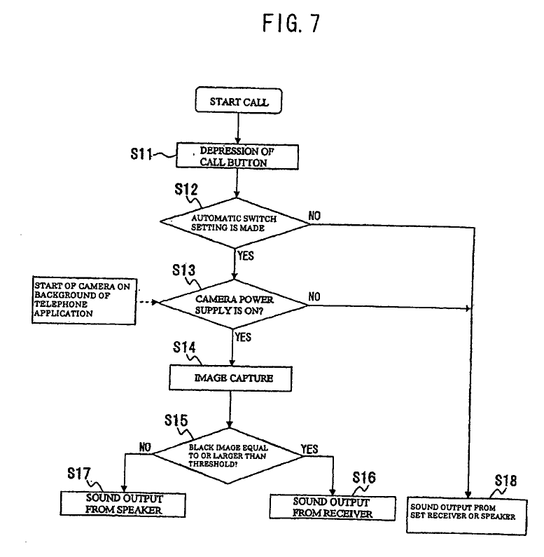

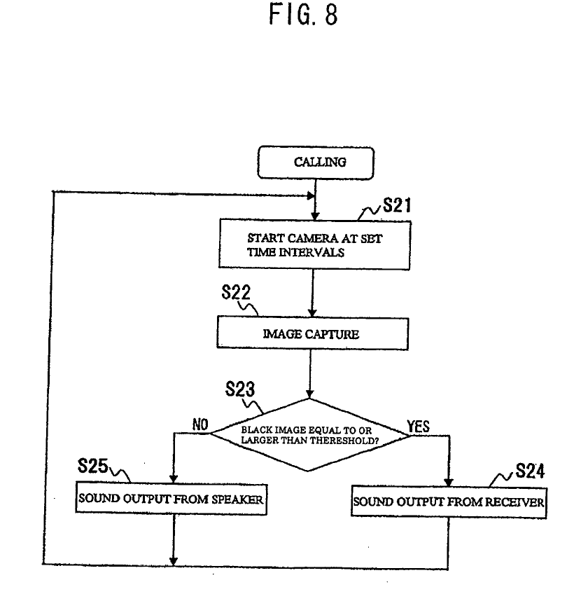

Call switching processing is next explained with reference to FIGS. 7 and 8. FIG. 7 is a flowchart showing an example of a processing procedure during start of a call at the time when the call switching program is caused to run. FIG. 8 is a flowchart showing an example of a processing procedure during a call at the time when the call switching program is caused to run. In the following explanation, the call switching program runs on a processor.

During start of a call, as shown in FIG. 7, in an incoming call or an outgoing call, when the user depresses the call button 56 of the portable terminal apparatus 2 (step Sil), judgment on whether an automatic switch setting is made is executed (step S12). This automatic switch setting is a setting for the call switching of the normal call and the hand-free call or the call switching of the normal call and the television telephone call. To perform the automatic switch setting, the user only has to perform processing from a menu screen of the portable terminal apparatus 2 according to an initial setting.

If the automatic switch setting is made in the portable terminal apparatus 2 (YES in step S12), the automatic switching program performs judgment on whether a camera power supply is ON as a check of the start of the camera 12 (step S13). The start of the camera 12 is executed on the background of the telephone application 82.

When the camera 12 is started, an image is detected by the camera 12. The call switching program executes capturing of the detected image (image capture) (step S14). The call switching program compares the detected image with the threshold of black elements and judges whether a black image equal to or larger than the threshold is included in the detected image (step S15). When a black image equal to or larger than the threshold is included in the detected image (YES in step S15), the call switching program judges that a position of the apparatus main body 4 is in contact with or near the human body 14, switches the television telephone call to the normal call, and causes the receiver 6 to output sound (step S16). Even if the portable terminal apparatus 2 is operating in a television telephone mode, after it is judged that, for example, the apparatus main body 4 is near the human body 14, the television telephone call is switched to the normal call.

When a black image equal to or larger than the threshold is not included in the detected image (NO in step S15), the call switching program judges that a position of the apparatus main body 4 is not in contact with or near the human body 14. In this case, if the call of the portable terminal apparatus 2 is the hand-free call or the television telephone mode is set, the call switching program switches the hand-free call to the television telephone call and causes the speaker 8 to output sound (step S17).

In such processing, when the automatic switch setting is not made in the portable terminal apparatus 2 (NO in step S12) or when the camera power supply is not turned on (e.g., the user fails in turning on the camera power supply) (NO in step S13), the receiver 6 or the speaker 8 selected in the portable terminal apparatus 2 in advance in the initial setting outputs sound (step S18).

Subsequently, in the processing procedure during a call, as shown in FIG. 8, in the portable terminal apparatus 2, the call switching program starts the camera 12 at set time intervals (step S21) and executes capturing of a detected image of the camera 12 (image capture) (step S22). The call switching program compares this detected image with the threshold of black elements and judges whether a black image equal to or larger than the threshold is included in the detected image (step S23). When a black image equal to or larger than the threshold is included in the detected image (YES in step S23), the call switching program judges that a position of the apparatus main body 4 is in contact with or near the human body 14, switches the television telephone call to the normal call, and causes the receiver 6 to output sound (step S24). Even if the portable terminal apparatus 2 is operating in the television telephone mode, when it is judged that a black image equal to or larger than the threshold is included in the detected image, the television telephone call is switched to the normal call.

When a black image equal to or larger than the threshold is not included in the detected image (NO in step S23), the call switching program judges that a position of the apparatus main body 4 is not in contact with or near the human body 14. If the call of the portable terminal apparatus 2 is the hand-free call or the television telephone mode is set, the call switching program switches the hand-free call to the television telephone call and causes the speaker 8 to output sound (step S25).

The processing in steps S21 to S25 is continuously repeated, for example, in a period in which the call is continued. According to a change of detected images, the call switching for sound output from the receiver 6 or sound output from the speaker 8 is continuously and automatically executed.

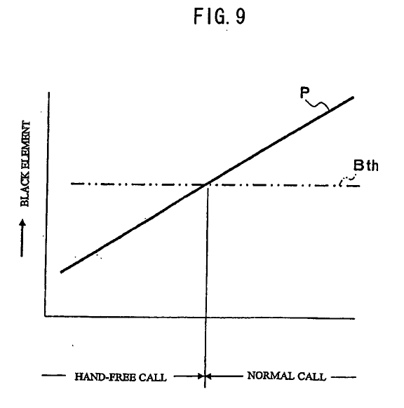

The call switching based on a detected image is next explained with reference to FIG. 9. FIG. 9 is a diagram showing a relation between a change of detected images and the call switching.

A form of an image acquired by the camera 12 depends on a position of the apparatus main body 4 with respect to the human body 14. Black elements in a detected image are different according to the position of the apparatus main body 4 with respect to the human body 14. In a position of the apparatus main body 4 shown in FIG. 1A, the human body 14 comes into contact with or approaches the optical system 32 of the camera 12. Thus, the apparatus main body 4 (the camera 12) is covered with the human body 14, a detected image becomes dark, and black elements increase in the analysis of the detected image. This occurs in the case of the normal call.

In a position of the apparatus main body 4 shown in FIG. 1B or FIG. 2, the human body 14 moves away from the optical system 32 of the camera 12 and a large amount of light enters the optical system 32 from around the apparatus main body 4. Therefore, a detected image becomes light and black elements decrease in the analysis of the detected image. This occurs in the case of the hand-free call or the television telephone call.

In order to judge a position of the apparatus main body 4 from the quantity of black elements included in the detected image in this way, as shown in FIG. 9, a threshold Bth is set for black elements for discriminating the normal call, the hand-free call, and the television telephone call. As a result of analyzing the detected image, if black elements in the detected image are equal to or larger than the threshold Bth, the call switching program judges that a position of the apparatus main body 4 is in contact with or near the human body 14 and, assuming that the apparatus main body 4 is in the normal call state, outputs sound from the receiver 6. On the other hand, if black elements in the detected image are smaller than the threshold Bth, the call switching program judges that a position of the apparatus main body 4 is not in contact with or near the human body 14 and, assuming that the apparatus main body 4 is in the hand-free call state or the television telephone call state, outputs sound from the speaker 8. If a position of the apparatus main body 4 is judged from the quantity of black elements included in the detected image according to such image analysis, it is possible to perform the call switching without malfunction according to the position of the apparatus main body 4.

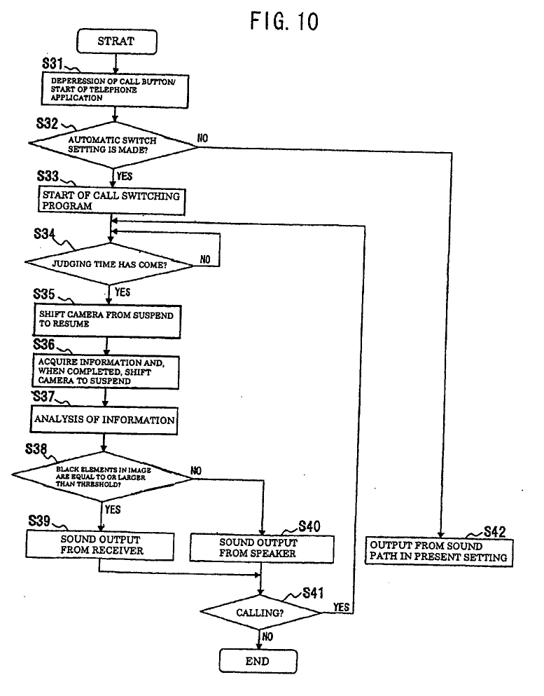

A second embodiment is explained with reference to FIG. 10. FIG. 10 is a flowchart showing a processing procedure of a call switching program of a portable terminal apparatus according to the second embodiment.

The second embodiment adopts a processing procedure of call switching processing of a portable terminal apparatus that repeats standby and resumption of an operation of the camera 12 at predetermined time intervals. In this embodiment, the portable terminal apparatus 2 (FIGS. 1, 2, 3, 4, 5, 6, and 9) used in the first embodiment is used.

In the processing procedure shown in FIG. 10, the telephone application 82 (FIG. 6) is started according to depression of the call button 56 (FIG. 5) (step S31) and it is checked whether the automatic switch setting is made (step S32). The check of the automatic switch setting is a check of a setting of call switching based on a detected image of the camera 12. When the automatic switch setting is made (YES in step S32), the call switching program is started (step S33). In this case, the call switching program as a switching program for a sound path is started on the basis of the judgment of the detected image by the camera 12 on the background of the telephone application 82.

When the call switching program is started, the call switching program judges whether a judging time for the detected image of the camera 12 has come (step S34). The judging time is set according to a setting mode for the judging time displayed on a screen when the screen is shifted from a standby screen to a menu screen of the portable terminal apparatus 2.

When the judging time has come (YES in step S34), the call switching program resumes the operation of the camera 12 on standby, i.e., shifts the camera 12 from a suspend state to a resume state (step S35). The call switching program acquires information from the camera 12. When the information acquisition is completed, the call switching program shifts the camera 12 to the suspend state (step S36). In other words, capturing of a detected image is performed.

Thereafter, the call switching program performs analysis of the acquired information (step S37). In the analysis in step S37, the call switching program extracts black elements from the detected image. The call switching program judges whether the black elements in the image are equal to or larger than the threshold as a result of the analysis in step S37 (step S38). When the black elements are equal to or larger than the threshold (YES in step S38), the call switching program causes the receiver 6 to output sound (step S39). When the black elements in the image is smaller than the threshold (NO in step S38), the call switching program causes the speaker 8 to output sound (step S40).

After such call switching, the call switching program appropriately checks whether the user is making a call (step S41). When the user is making a call (YES in step S41), the call switching program returns to step S34 and continuously and automatically executes the processing (steps S34 to S40). When the call is finished (NO in step S41), the call switching program finishes the processing in FIG. 10.

In step S32, when the automatic switch setting is not made in the portable terminal apparatus 2 (NO in step S32), the call switching program outputs a sound signal from the sound path in the present setting. When the receiver 6 or the speaker 8 is designated in the present setting for outputting sound, sound is outputted from the receiver 6 or the speaker 8 (step S42).

As described above, in this embodiment, it is possible to cause the camera 12 to operate at the predetermined time intervals, automatically switch the sound path according to the analysis of a detected image, and cause the receiver 6 to output sound in the normal call or cause the speaker 8 to output sound in the hand-free call or the television telephone call.

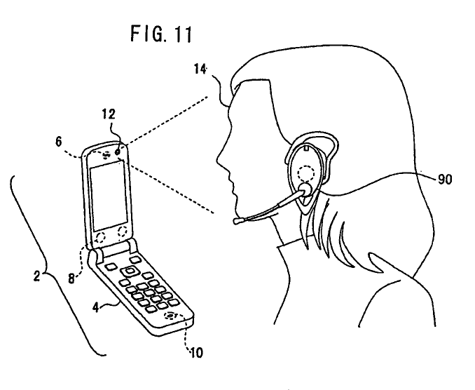

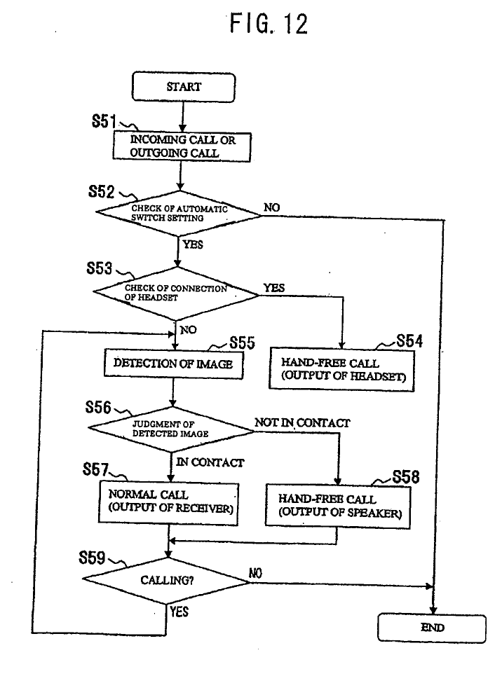

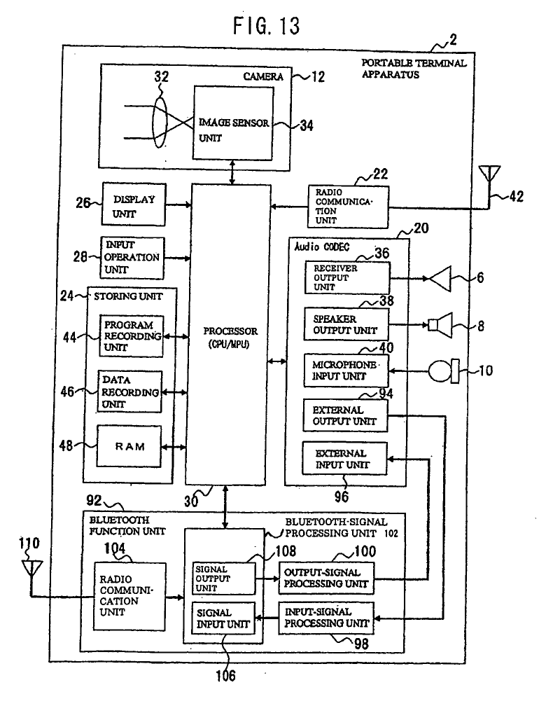

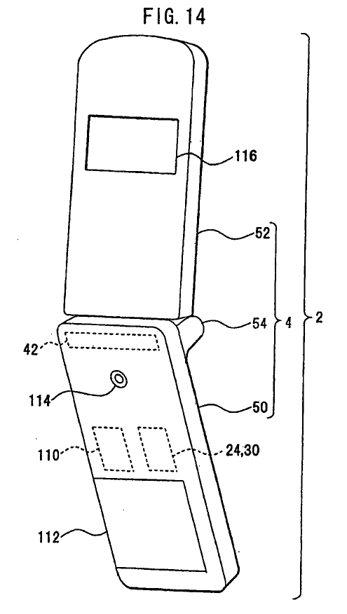

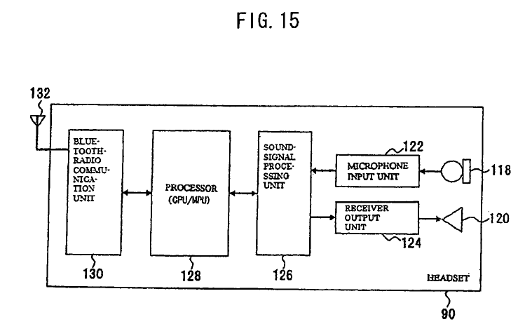

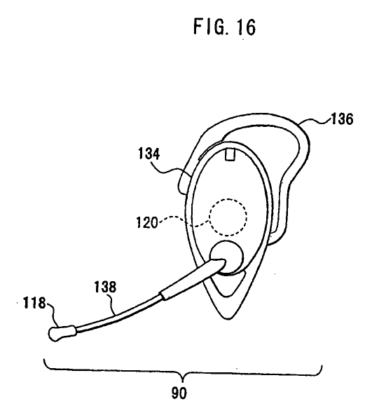

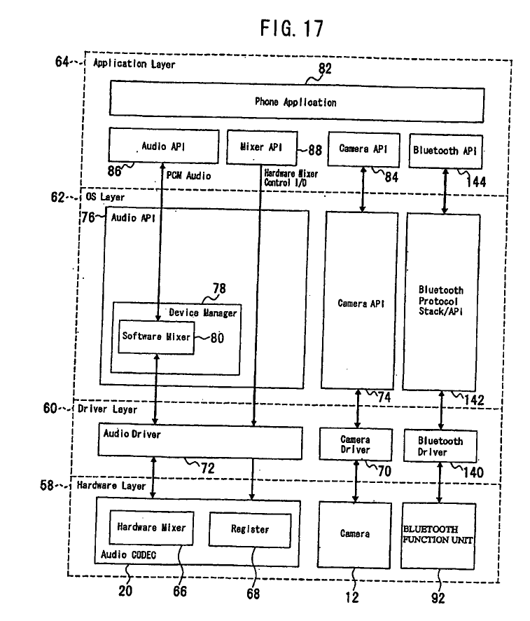

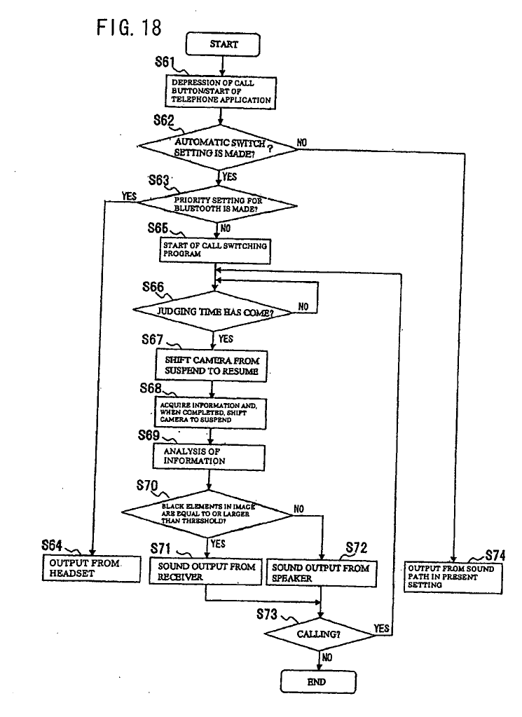

A third embodiment is explained with reference to FIGS. 11, 12, 13, 14, 15, 16, 17, and 18. FIG. 11 is a diagram showing an automatic call switching function of a portable terminal apparatus according to the third embodiment. FIG. 12 is a flowchart showing an example of a call switching method for the portable terminal apparatus. FIG. 13 is a diagram showing an example of a configuration of hardware of the portable terminal apparatus. FIG. 14 is a diagram showing an example of the structure of the portable terminal apparatus. FIG. 15 is a diagram showing an example of a configuration of hardware of a headset. FIG. 16 is a diagram showing an example of the structure of the headset. FIG. 17 is a diagram showing a hierarchical structure of software processing by the portable terminal apparatus. FIG. 18 is a flowchart showing a processing procedure of a call switching program of the portable terminal apparatus. In FIGS. 11, 13, 14, 15, 16, and 17, components identical with those in FIGS. 1, 2, 5, and 6 are denoted by the identical reference numerals.

In the third embodiment, an external apparatus for performing the hand-free call is connected to the portable terminal apparatus 2 by a radio signal. Priority is given to a call performed through the external apparatus connected to the portable terminal apparatus 2. In this embodiment, as shown in FIG. 11, a headset 90 is used as a transmitting and receiving device for performing the hand-free call. The headset 90 is set on the human body 14 of the user and connected to the portable terminal apparatus 2 by a signal of Bluetooth radio, which is short-distance radio. A call is made through the headset 90.

As shown in FIG. 12, the portable terminal apparatus 2, to which the headset 90 as the external apparatus is connected by a radio signal as described above, checks, on the basis of an incoming call or an outgoing call by the depression of the call button 56 or the like (step S51), presence or absence of an automatic switch setting for call switching (step S52) and then checks whether the headset 90 is connected thereto (step S53). When the headset 90 is connected to the portable terminal apparatus 2, the portable terminal apparatus 2 transmits and receives sound through the headset 90 as the hand-free call (step S54)

Other steps, i.e., step S55 (detection of an image), step S56 (judgment of a detected image), step S57 (normal call: output of the receiver 6), step S58 (hand-free call: output of the speaker 8), and step S59 (judgment on whether the user is making a call) are the same as steps S3 to S7 of the flowchart in FIG. 3.

When the head set 90 is connected to the portable terminal apparatus 2, if priority is given to transmission and reception of sound by the headset 90, convenience of the call switching is improved.

In the portable terminal apparatus 2 to which the headset 90 is connected by the Bluetooth radio signal, as shown in FIG. 13, a Bluetooth function unit 92 is set. In association with the Bluetooth function unit 92, an external output unit 94 and an external input unit 96 for transmitting and receiving a sound signal using the Bluetooth radio signal are set in the audio codec 20.

The Bluetooth function unit 92 includes an input-signal processing unit 98, an output-signal processing unit 100, a Bluetooth-signal processing unit 102, and a radio communication unit 104. The input-signal processing unit 98 captures an output signal from the external output unit 94 of the audio codec 20, applies signal processing such as analog-to-digital conversion to the output signal, and outputs a PCM signal. The output-signal processing unit 100 performs signal processing for, for example, reproducing a sound signal from the PCM signal from the Bluetooth-signal processing unit 102 and inputs the sound signal to the external input unit 96 of the audio codec 20.

The Bluetooth-signal processing unit 102 is a Bluetooth module and includes a signal input unit 106 that captures the PCM signal and a signal output unit 108 that outputs the PCM signal. The radio communication unit 104 includes an antenna for Bluetooth 110 and transmits a Bluetooth radio signal to and receives the Bluetooth radio signal from the headset 90 as a Bluetooth apparatus.

In the portable terminal apparatus 2, as shown in FIG. 14, in the housing unit 50 of the apparatus main body 4, the storing unit 24, the processor 30, the antenna 42, the antenna for Bluetooth 110, and a battery 112 are built and a camera for outside photographing 114 is set. A sub-display unit 116 is set in the housing unit 52.

The headset 90 corresponding to the portable terminal apparatus 2 includes, as shown in FIG. 15, a microphone 118 and a receiver 120. A transmission sound signal from the microphone 118 is captured into a sound-signal processing unit 126 through a microphone input unit 122. A reception sound signal outputted from the sound-signal processing unit 126 is applied to the receiver 120 from a receiver output unit 124 and outputted as sound.

The sound-signal processing unit 126 is controlled by a processor 128. A Bluetooth-radio communication unit 130 is also controlled by the processor 128. The Bluetooth-radio communication unit 130 includes a Bluetooth radio signal antenna 132 and performs transmission and reception of a Bluetooth radio signal.

As shown in FIG. 16, the headset 90 includes a main body unit 134. Functional units such as the processor 128, the Bluetooth-radio communication unit 130, and the receiver 120 are mounted on the main body unit 134. The main body unit 134 includes an ear hook unit 136. The microphone 118 is attached to the main body unit 134 via a movable arm portion 138.

In software processing for the automatic call switching of the portable terminal apparatus 2 cooperating with such a headset 90, as shown in FIG. 17, the Bluetooth function unit 92 is set in the hardware layer 58, a Bluetooth driver 140 is set in the driver layer 60, a Bluetooth protocol stack application 142 is set in the OS layer 62, and a Bluetooth application 144 is set in the application layer 64. With such a structure, when the headset 90 is connected to the portable terminal apparatus 2, priority of the headset 90 is realized. When the headset 90 is not connected to the portable terminal apparatus 2, as described above, the camera 12 detects an image showing whether the apparatus main body 4 is in contact with or near the human body 14. According to the acquisition of the detected image, the detected image is captured into the camera application 74 through the camera driver 70. The sound path is controlled by the hardware mixer 66 and the software mixer 80. As a result, the automatic switching of the normal call and the hand-free call and the automatic switching of the normal call and the television telephone call are executed in the same manner as described above.

In the third embodiment, the processing for priority setting for the Bluetooth apparatus is added to the processing procedure described above (FIG. 10). When the headset 90 is connected to the portable terminal apparatus 2, transmission and reception by the headset 90, which is a form of the hand-free call, is performed.

In this processing procedure, as shown in FIG. 18, the telephone application 82 (FIG. 6) is started by the depression of the call button 56 (FIG. 5) (step S61). The telephone application 82 checks whether the automatic switch setting described above is made (step S62). The check of the automatic switch setting is a check of a setting of call switching based on a detected image of the camera 12. When the automatic switch setting is made (YES in step S62), the telephone application 82 checks whether priority setting for Bluetooth is made (step S63). When the priority setting for Bluetooth is made (YES in step S63), the telephone application 82 outputs sound from the headset 90 (step S64). When the priority setting for Bluetooth is not made (NO in step S63), the telephone application 82 starts a call switching program (step S65). In this case, the call switching program as a switching program for a sound path based on the judgment of the detected image by the camera 12 is started on the background of the telephone application 82 as described above.

In this case, sound captured into the headset 90 is converted into a Bluetooth radio signal and transmitted from the antenna 132 to the portable terminal apparatus 2. The Bluetooth radio signal transmitted from the portable terminal apparatus 2 is received by the Bluetooth-radio communication unit 130, converted into a sound signal, and outputted from the receiver 120.

In this embodiment, check of the coming of a judging time (step S66), shift of the camera 12 from the suspend state to the resume state (step S67), shift of the camera 12 to the suspend state after acquisition of information (step S68), analysis of information (step S69), judgment on whether black elements in an image is equal to or larger than the threshold (step S70), call switching (steps S71 and S72), judgment on whether the user is making a call (step S73), and output from a sound path in the present setting (step S74) are the same as those in the processing procedure shown in FIG. 10. Thus, explanation of the steps is omitted.

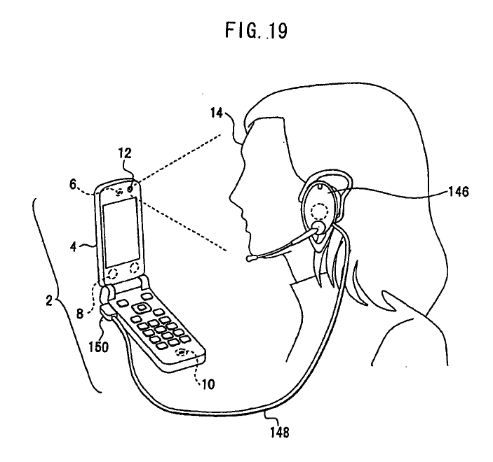

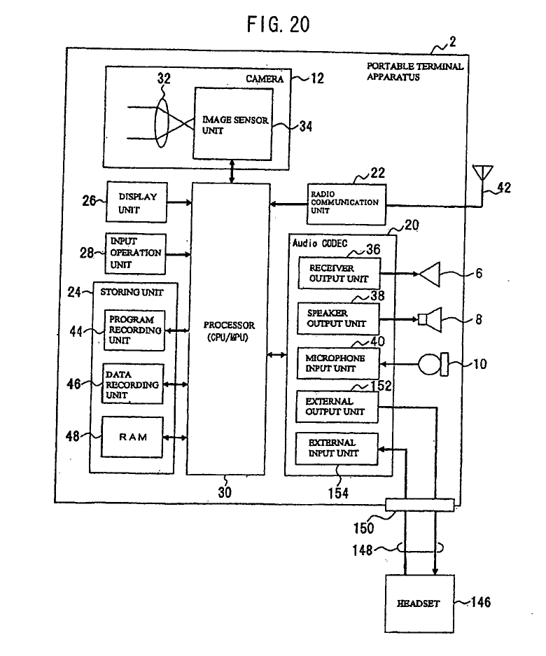

A fourth embodiment is explained with reference to FIGS. 19 and 20. FIG. 19 is a diagram showing an automatic call switching function of a portable terminal apparatus according to the fourth embodiment. FIG. 20 is a diagram showing an example of a configuration of hardware of the portable terminal apparatus. In FIGS. 19 and 20, components identical with those in FIGS. 11 and 13 are denoted by the identical reference numerals.

In the third embodiment, the headset 90 (FIG. 11) connected by radio according to the Bluetooth radio signal is described as an example. However, as shown in FIG. 19, a headset 146 as an external apparatus may be connected to the portable terminal apparatus 2 by a cable 148 and a connector 150. When the headset 146 is connected to the portable terminal apparatus 2, the connection of the headset 146 is detected and the headset 146 is give priority over the receiver 6, the speaker 8, and the microphone 10. Transmission and reception are performed from the headset 146 as the hand-free call.

In this case, in the portable terminal apparatus 2, as shown in FIG. 20, the headset 146 only has to be connected to an external output unit 152 and an external input unit 154 by the connector 150.

With such a structure, as in the third embodiment, it is possible to output sound to the headset 146.

(1) In the embodiments, the camera 12 is discontinuously started at the set time intervals. However, it is also possible that the camera 12 is continuously maintained in a driving state during a call and detected images are captured at the set time intervals to discontinuously perform image judgment.

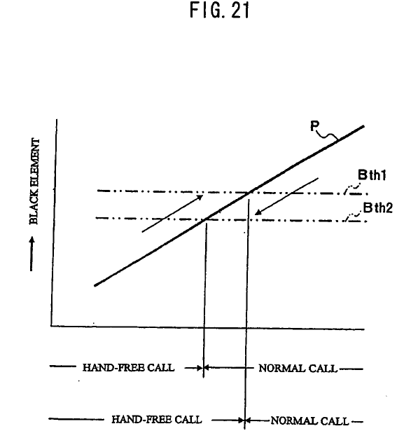

(2) In the embodiments, the threshold Bth of black elements is set for a detected image. However, if plural thresholds Bth1 and Bth2 are set (Bth1>Bth2) as shown in FIG. 21, the threshold Bth1 is used when the portable terminal apparatus shifts from the state of the hand-free call to the normal call, and the threshold Bth2 is used when the portable terminal apparatus shifts from the normal call to the state of the hand-free call, it is possible to prevent chattering of the call switching and perform smooth call switching.

(3) In the embodiments, the portable terminal apparatus 2 in which the apparatus main body 4 has the folding structure is described as an example. However, the present disclosure may be a portable terminal apparatus in which the housing units 50 and 52 slide with respect to each other to be capable of opening and closing or rotate to open and close. The present disclosure is also applicable to a portable terminal apparatus of a form in which housings do not open and close.

(4) In the embodiments, the in-camera for the television telephone is also used as the camera 12. However, a dedicated camera for detecting a position of the apparatus main body 4 may be set.

What is claimed is:

1. A terminal apparatus comprising:
an imaging unit that images an image;
a detecting unit that detects a position of the terminal apparatus using the image imaged by the imaging unit; and
a call switching unit that switches a normal call and a hand-free call on the basis of a result of the detection of the detecting unit.

2. The terminal apparatus according to claim 1, wherein
the hand-free call is a call performed by using a television telephone function, and
the call switching unit automatically switches the normal call and the television telephone call on the basis of the result of the detection of the detecting unit.

3. The terminal apparatus according to claim 1, further comprising:
a receiver that outputs sound; and
a speaker that outputs sound, wherein
the call switching unit causes the receiver to output sound in the normal call and causes the speaker to output sound in the hand-free call.

4. The terminal apparatus according to claim 1, wherein the call switching unit, according to the result of the detection of the detecting unit, switches a call to the normal call when the terminal apparatus is in the position of an ear of a user of the terminal apparatus and switches the call to the hand-free call when the terminal apparatus is apart from the position of the ear of the user of the terminal apparatus.

5. The terminal apparatus according to claim 1, wherein
a threshold for the image is set in the detecting unit, and
the call switching unit switches the normal call and the hand-free call on the basis of the result of comparison of the image and the threshold.

6. The terminal apparatus according to claim 1, wherein the detecting unit starts the imaging unit at predetermined time intervals and captures images during a call by the terminal apparatus.

7. The terminal apparatus according to claim 1, wherein the detecting unit captures images imaged by the imaging unit at predetermined time intervals during a call by the terminal apparatus.

8. The terminal apparatus according to claim 1, wherein the detecting unit detects the position of the terminal apparatus according to color components in the image imaged by the imaging unit.

9. The terminal apparatus according to claim 1, wherein the detecting unit detects the position of the terminal apparatus according to a quantity of black elements in the image imaged by the imaging unit.

10. The terminal apparatus according to claim 1, wherein
an external apparatus that inputs and outputs sound is connected to the terminal apparatus by a wire or a radio signal, and
the call switching unit switches a call to the external apparatus when the external apparatus is connected to the terminal apparatus.

11. A call switching method of switching a first call operation and a second call operation comprising:
detecting a position of a communication apparatus according to an imaged image; and
switching the first call operation and the second call operation on the basis of a result of the detection of the communication apparatus position.

12. The call switching method according to claim 11, wherein
the first call operation is a normal call and the second call operation is a hand-free call, and
according to the imaged image, a call is switched to the normal call when the communication apparatus is in the position of an ear of a user and switched to the hand-free call when the communication apparatus is apart from the position of the ear.

13. The call switching method according to claim 11, wherein
the imaged image is captured at predetermined time intervals during a call performed by using the communication apparatus, and
the first call operation and the second call operation are switched on the basis of the captured image.

14. The call switching method according to claim 11, further comprising switching the first call operation and the second call operation according to color components in the imaged image.

15. A recording medium mounted on a communicable terminal apparatus and having readably stored therein a call switching program when executed, implements:
capturing an image representing a position of the terminal apparatus; and
switching a normal call and a hand-free call on the basis of the captured image.

16. The recording medium according to claim 15, wherein, according to the captured image, a call is switched to the normal call when the terminal apparatus is in the position of an ear of a user and switched to the hand-free call when the terminal apparatus is apart from the position of the ear.

17. The recording medium according to claim 15, wherein
the captured image is captured at predetermined intervals during a call, and
the normal call and the hand-free call are switched on the basis of the captured image.

18. The recording medium according to claim 15, wherein the normal call and the hand-free call are switched according to color components in the captured image.
